(19) United States
(12) Patent Application Publication
(10) Pub. No.: US 2009/0184184 A1
(43) Pub. Date: Jul. 23, 2009

(54) Fuel Injector and Method for Its Mounting

(76) Inventors: Helmut Schwegler, Pleidelsheim (DE); Ferdinand Reiter, Markgroeningen (DE); Franz Thoemmes, Bietigheim-Bissingen (DE)

Correspondence Address: KENYON & KENYON LLP, ONE BROADWAY, NEW YORK, NY, 10004, US

(21) Appl. No.: 11/887,716

(22) PCT Filed: Mar. 7, 2006
(86) PCT No.: PCT/EP2006/060502

§ 371 Date: Jan. 5, 2009

(30) Foreign Application Priority Data
Apr. 28, 2005 (DE) 102005019837.6

(51) Int. Cl. F02M 51/00; F02M 55/02; F02M 61/14

(52) U.S. Cl. 239/585.1; 123/469; 123/470

(57) ABSTRACT

A fuel injector, in particular a fuel injector for fuel-injection systems of internal combustion engines, having an inflow nipple for the connection to a fuel-distributor line, a nozzle body disposed downstream from the inflow nipple, a magnetic circuit element, which includes a solenoid coil an inner pole, and an outer pole, as well as an armature, which is in force-locking connection with a valve needle such that a valve-closure element disposed at the valve needle lifts off from a valve-seat surface when solenoid coil is energized, the inflow nipple and the nozzle body being produced as deep-drawn components, and the inflow nipple and the nozzle body being fixed in place on the magnetic circuit element.

### FIELD OF THE INVENTION

The present invention is based on a fuel injector, and on a method for mounting such a fuel injector.

### BACKGROUND INFORMATION

A fuel injector which is suitable for fuel-injection systems of internal combustion engines, in particular, is discussed in DE 197 12 922 A1, for instance. It includes a housing, an intake nipple the connection to a fuel supply line, a valve-seat support disposed downstream from the intake nipple, a valve-seat body affixed on the valve-seat support and having a valve-seat surface and a valve-closure element which is movable between a closed position resting against the valve-seat surface, and an open position lifted off therefrom. The intake nipple and the valve-seat support are each made of a sheet metal piece, which is deformed through deformation loading, the pieces being joined to one another to form a housing.

A special disadvantage of the fuel injector from the aforementioned printed publication is the large number of required components and the attendant high expense with regard to manufacture and installation. In addition, the illustrated fuel injector is difficult to mount.

### SUMMARY OF THE INVENTION

In contrast, the fuel injector according to the present invention, having the features described herein, and the method according to the present invention, having the features described herein, have the advantage that the fuel injector is made up of few structural components, which are able to be either preassembled or produced and mounted in an uncomplicated manner, in that an intake nipple and a nozzle body are designed as deep-drawn components, which are affixed on a magnetic circuit element.

Advantageous further developments of the fuel injector are rendered possible by the measures elucidated in the dependent claims.

In an advantageous manner, deep-drawn components are able to be varied widely in their shape and development so as to allow an optimal adaptation to the installation conditions of the fuel injector.

Furthermore, it is advantageous that the deep-drawn components are easy and inexpensive to produce.

In addition, it is advantageous that, due to the simple configuration, the dynamic flow rate may be adjusted prior to the final mounting of the fuel injector.

Furthermore, it is advantageous that components of other fuel injectors may be used in combination with the deep-drawn components without any redesign being required.

An exemplary embodiment of the present invention is represented in simplified form in the drawing and elucidated in greater detail in the description that follows.

### BRIEF DESCRIPTION OF THE DRAWINGS

FIG. 1 shows A schematic section through a fuel injector according to the related art.

FIG. 2 shows a schematic section through an exemplary embodiment of a fuel injector configured according to the present invention.

### DETAILED DESCRIPTION

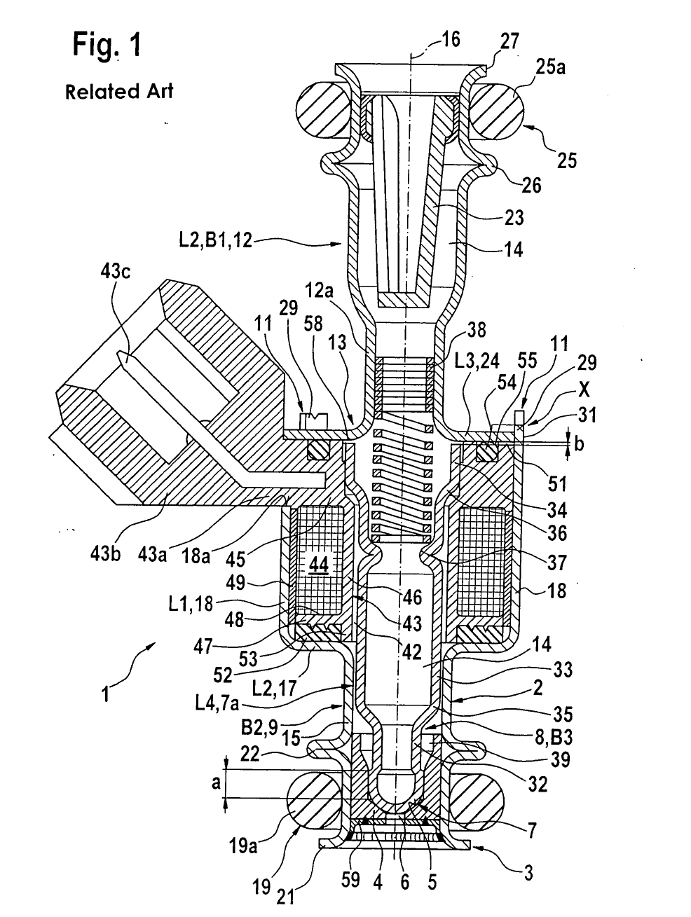

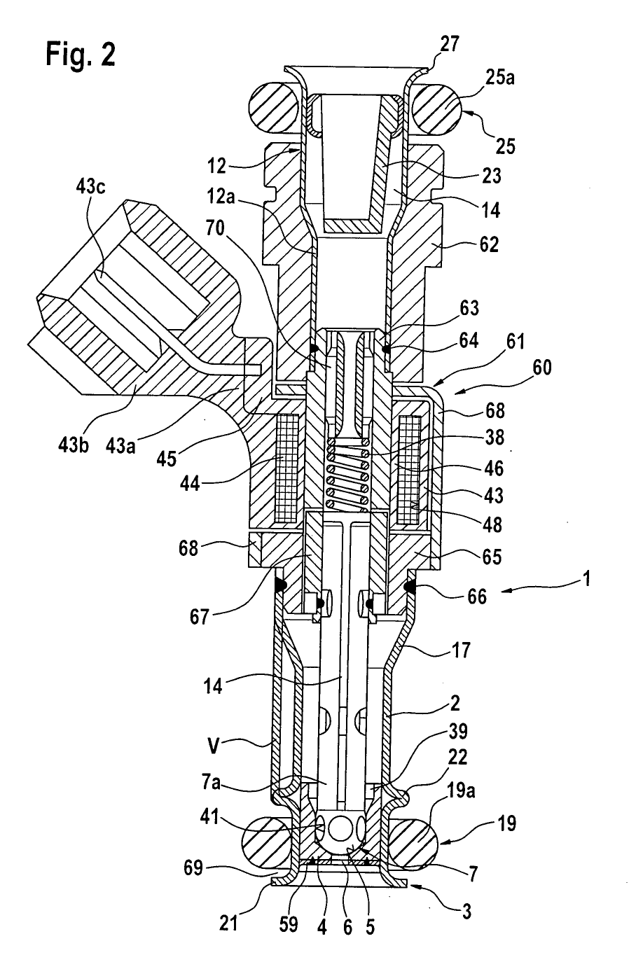

Before describing an exemplary embodiment of the present invention by way of example with the aid of FIG. 2, a fuel injector according to the related art will be described with respect to its essential features according to FIG. 1 for better understanding of the exemplary embodiments and/or the exemplary methods of the present invention.

Fuel injector 1 according to FIG. 1 is suitable for fuel-injection systems of mixture-compressing, externally ignited internal combustion engines and has a nozzle body 2. By its free end, nozzle body 2 forms discharge-side end 3 of fuel injector 1. A valve-seat body 4 has a conical valve-seat surface 5, which faces away from discharge-side end 3 and is disposed next to a recess 6 in the direction of discharge-side end 3. Valve-seat surface 5 cooperates with a valve-closure element 7, which in the present design has a sphere-segment-shaped design, at least in its region adjacent to valve-seat surface 5, and forms a hollow valve needle 8 together with an integrally formed shaft 7a. Valve-seat element 7 is disposed and affixed inside a sleeve-shaped valve-seat support 9. At its end facing away from discharge-side end 3, via a mechanical connection 11, valve-seat support 9 is connected to a sleeve-shaped inflow nipple 12 with which it forms a sleeve-shaped housing 13 inside of which a flow passage 14 for the fuel extends in an axially continuous manner.

Valve-seat support 9, which has a round cross section, has a diameter that widens in a stepwise manner in its upstream end region, thereby resulting in an essentially hollow-cylindrical circumferential wall section 15 in the downstream end region, which, upstream, is followed by a stepped wall section 17 which may be disposed at a right angle relative to longitudinal center axis 16 of housing 13, and a second hollow-cylindrical wall section 18. In the downstream end region of valve-seat support 9 there is an annular seal 19 formed by an O-ring 19a, for instance, to seal valve-seat support 9 in a receiving opening in which it is situated. Two flanges 21, 22, which have an axial clearance with respect to one another and accommodate O-ring 19a between them, are premolded on valve-seat support 9 for axial fixation of annular seal 19, upstream flange 22 being formed by what may be a folded external crimp.

Inflow nipple 12 likewise has the form of a cylindrical or stepped cylindrical sleeve, which in the present design widens in a stepwise manner in its cross-sectional size in its upstream end region in order to accommodate a filter 23. Premolded on the downstream end of inflow nipple 12 is a flange 24 whose outer diameter roughly corresponds to the outer diameter of second circumferential wall section 18 of valve-seat support 9. In the upstream end region, an annular seal 25, which may be an O-ring 25a surrounding inflow nipple 12, is assigned to inflow nipple 12 to seal a fuel line (not shown), which is able to plugged into inflow nipple 12. For axial fixation of sealing ring 25a, inflow nipple 12 has two integrally premolded flanges 26, 27, which have an axial clearance relative to one another and accommodate sealing ring 25a between them, upstream flange 26 being formed by an external crimp, which may be folded, if appropriate.

Mechanical connection 11 between valve-seat support 9 and inflow nipple 12 is in the form of a keyed connection. To this end, a plurality of connection lugs 29, which engage with the other part with form locking or which overlap it, may be disposed on one of these components. In the present development, two or more, such as three, connection lugs 29 are integrally molded on valve-seat support 9, the connection lugs being distributed across the circumference and projecting through associated edge-side recesses 31 in flange 24 having a corresponding cross-sectional form, and which are caulked by at least one notch at its side facing away from valve-closure element 7, or which are bent over and thereby grip flange 24 from behind with form locking and secure it on valve-seat support 9.

Valve needle 8 is formed together with valve-closure element 7 in the form of a one-piece cylindrical or stepped cylindrical sleeve having a sealed end on the downstream side. It has three circumferential wall sections 32, 33, 34, which have diameters of different size and extend one after the other in their longitudinal direction, the cross sections progressively enlarging upstream, which may be via conical transition regions 35, 36. Center circumferential wall section 33 has an inner flange 37, which is formed by an inside crimp. Center and upstream circumferential wall sections 33, 34 have a hollow-cylindrical cross-sectional form.

Inner flange 37 is used as shoulder surface and counter support for a restoring spring 38 disposed upstream thereform, which is in the form of a helical compression spring whose upstream end region has an oversized diameter relative to the inner diameter of circumferential wall 12a of input nipple 12, circumferential wall 12a having a tapered cross section here, the restoring spring being pressed into hollow-cylindrical circumferential wall 12a. The press fit for restoring spring 38 in circumferential wall 12a resulting from the magnitude of the oversize is so stable that unintended slippage of the pressed-in spring end is impossible during operation of fuel injector 1 given the stresses that come about during operation, but nevertheless allows the installation of restoring spring 38 by insertion into hollow-cylindrical circumferential wall 12a at a specific axial press-in force. Fuel injector 1 is opened by axial movement of valve needle 8 counter to the spring force of restoring spring 38.

Valve-seat surface 5 is formed by the shoulder surface of a recess 39, which is in sliding contact with the lateral surface of valve-closure element 7 in a longitudinal section a that extends upstream from valve-seat surface 5, has a divergent design upstream therefrom, and ends with axial clearance in front of transition region 35 of valve needle 8. Longitudinal section a forms an axial guide section 41 for valve-closure element 7. In order to provide a passage for the fuel in the region of this guidance, the cross-sectional form of either the inner lateral surface of recess 39, but which may be the outer circumferential surface in the radial outer wall region of sphere-segment-shaped valve-closure element 7, has a polygonal design including tangential surfaces on valve-seat body 4 (not shown) that extend between the corners, or secantial surfaces 7b on valve-closure element 7. In the present design, the radial equatorial region of sphere-segment-shaped valve-closure element 7 has a corresponding polygonal, e.g., hexagonal, design.

Disposed in free annular space 42 which is radially delimited on one side by circumferential wall section 18 of valve-seat support 9 and valve needle 8, and by stepped wall section 17 of valve-seat support 9 and flange 24 of inflow nipple 12 on the other side, is an annular coil body 43, which may be made of plastic, in which a solenoid coil 44 is embedded, which allows an electromagnetic actuation of valve needle 8. Coil body 43 is made up of an annular base part 45, which rests against flange 24 and circumferential wall section 18. Downstream, a hollow-cylindrical inner circumferential wall 46 extends from the inner circumference of base part 45, inner circumferential wall 46 having a flange 47 which delimits an annular space 48 in which solenoid coil 44 is embedded and covered by a sleeve 49 made of electrically non-conductive material, especially plastic.

The axial dimension of coil body 43 may be selected long enough so that it fills the clearance between flange 24 and stepped wall section 17. This already makes it possible to realize sealing of the inner space of fuel injector 1 with respect to a separation seam 51 between valve-seat body 4 and inflow nipple 12. Annular seals, in this case a separate sealing ring, may be provided at the axial end faces of coil body 43. In the present design, a quad ring 52, which sits on an axial annular projection 53 of coil body 43, is disposed at the downstream end face. Upstream, an O-ring 54 is disposed in an annular groove 55 in the upstream end face of coil body 43 accommodating it. Integrally molded on the side on coil body 43 is a connection collar 43a, which extends in an outward direction through a fitting opening 18a, discharging upstream, in circumferential wall 18, and which bears a plug connector 43b having electrical contact elements 43c, which are connected to solenoid coil 44.

Valve needle 8 is assigned a guide section 56 formed by coil body 43. In the present design, guide section 56 is provided between upstream circumferential wall section 34 and base part 45 with whose cylindrical inner circumferential surface, which may be reduced in its cross section, the cylindrical outer circumferential surface of circumferential wall section 34 is in sliding contact. Base part 45 may have a widened region in the upstream region of its inner circumference, whereby a free annular gap 57 is formed for the upstream outer edge of valve needle 8. Shaft 7a has a radial clearance with respect to coil body 43 and circumferential wall section 15 between guide sections 41, 56.

The length of valve needle 8 is of sufficient size so that, when its valve-closure element 7 is resting against valve-seat surface 5, an axial clearance b exists between valve needle 8 and flange 24 of inflow nipple 12, which corresponds to the valve needle lift. Inflow nipple 12, in the exemplary embodiment its flange 24, therefore forms a stop 58 for the lifting movement of valve needle 8. That is to say, valve needle 8 completely projects through solenoid coil 44. Inflow nipple 12 conducting the magnetic flux therefore does not form a core within the meaning of known electromagnetically actuable valves, but represents only a housing part that may have thin walls. Valve needle 8 forms the magnetic core of solenoid coil 44. A special armature body to be affixed on valve needle 8 is not required.

Valve-seat support 9, inflow nipple 12 and valve needle 8 are each formed from a molded sheet metal piece made from ferromagnetic metal, in particular ferromagnetic steel, which is deformable into its final form from a blank or a prefabricated part, which may be by deep-drawing, with the aid of deformation loading that exceeds the elastic limit, such as tensile or compressive loading of its material. The blank or prefabricated part may be a planar sheet bar or a tubular piece, for example. Therefore, valve-seat support 9, inflow nipple 12 and valve needle 8 are in each case a sheet metal component B1, B2, B3, formed in one piece and having an essentially identical wall thickness, which is able to be produced in an uncomplicated and rapid manner with the aid known deformation measures, and which is characterized by relatively high strength and stability at low weight. It is also possible to integrally mold secantial surfaces 7b on valve-closure element 7. However, secantial surfaces 7b may also be produced by cutting reworking.

A, for example, cup-shaped spray-orifice plate 59, which may be of from steel, is used for axial fixation of valve-seat body 4; its circumferential edge is adapted to the inner cross-sectional size of valve-seat support 9 and it is affixed in what may be an axially flush-mounted position at the discharge-side end, at its inner wall, which may be by welding. To fix valve-seat body 4 in place in the axial direction, it is joined to spray-orifice plate 59 by welding. The valve-seat component made up of valve-seat body 4 and spray-orifice plate 59 is fixedly connected to valve-seat support 9 in the region of spray-orifice plate 59, by welding.

The sections of valve-seat support 9, inflow nipple 12 and valve needle 8 delimiting annular space 42, in the exemplary embodiment, circumferential wall section 18, stepped wall section 17, flange 24 and shaft 7a of valve needle 8, form conductive elements L1, L2, L3, L4 for the magnetic flux of solenoid coil 44.

During operation the fuel flows axially through inflow nipple 12 and shaft 7a of valve needle 8, the shaft being open upstream. Disposed in front of valve-closure element 7, in beveled transition region 35 between circumferential sections 32, 33 in the exemplary embodiment, are through holes in the jacket of shaft 7a from which the fuel continuous its axial flow in the direction of valve-seat surface 5.

The afore-described exemplary embodiment of a fuel injector 1 according to the related art has several disadvantages with regard to the manufacture and assembly of the individual components, which may lead to high expense in the production of fuel injector 1 and to poor durability and thereby to damage during operation of fuel injector 1.

In particular the connection of nozzle body 2 to inflow nipple 12 in the form of a clip connection is susceptible to faults.

As can be gathered from FIG. 1, the manufacture of the individual components requires great precision and a multitude of additional components for sealing and encapsulating the components of the magnetic circuit.

In the following text an exemplary embodiment of a fuel injector 1 configured according to the present invention is illustrated, which, in contrast, has a considerably simplified design, so that the aforementioned disadvantages are able to be circumvented and the production and installation costs for the fuel injector lowered considerably while simultaneously enabling a reliable connection of fuel injector 1 to an intake manifold or a fuel-distributor line.

According to the exemplary embodiments and/or the exemplary methods of the present invention, as illustrated in FIG. 2 with the aid of an exemplary embodiment of a fuel injector 1 configured according to the present invention, intake nipple 12 and nozzle body 2 are produced as deep-drawn components, which are assembled together with a pre-manufactured magnetic circuit element 60. Identical components have been provided with matching reference numerals in FIG. 2. A repetitious description of already discussed components was dispensed with.

In contrast to the exemplary embodiment of a fuel injector 1 according to the related art described earlier, the exemplary embodiment of a fuel injector 1 according to the present invention described in FIG. 2 has a magnetic circuit element 60 including a tubular inner pole 63 as well as an outer pole 65 and an armature 67 guided therein, which is connected to valve needle 7a by force-locking. A housing component 68 as part of the outer pole encapsulates magnetic circuit element 60.

Magnetic circuit element 60 may be premanufactured and is provided with inflow nipple 12 and nozzle body 2 in a final step. To this end, at an inflow-side end 61 of magnetic circuit element 60, inflow nipple 12 is first placed on, for instance, a step of inner pole 63 and connected to tubular inner pole 63 of magnetic circuit element 60 via a welding seam 64, which may be by laser welding.

A spacer 62 by which sealing ring 25a is retained on inflow nipple 12 to seal from a fuel-distributor line (not shown further), may either be slipped onto inflow nipple 12 and mounted together with it, so that, after welding, spacer 62 merely needs to be slipped axially into its final position in the discharge direction, over welding seam 64, or else spacer 62 may be designed in the form of two semi-spheres, which are mounted around inflow nipple 12 after welding.

On the downstream side of magnetic circuit element 60, nozzle body 2 is mounted in an analogous manner in that it is placed on top of an outer pole 65 of magnetic circuit element 60 or is connected thereto via a welding seam 66. Here as well, laser welding, in particular, suggests itself as welding technology.

The two components, inflow nipple 12 and nozzle body 2, are designed as deep-drawn components. This advantageously reduces the manufacturing cost, since, due to the production using metal cutting technology, the manufacture is able to be limited to a few components in the region of magnetic circuit element 60. Furthermore, the components have the advantage of being lightweight so that they do not contribute needless weight to the overall weight.

In addition, deep-drawing is a method that allows great variation and flexibility with regard to the length and the connection geometries. As an example of this, another variant is schematically shown in the region of nozzle body 2, on the left in FIG. 2, and denoted by V, which largely dispenses with flange 22 providing the local securing of O-ring 19a, in that the diameter of nozzle body 2 remains constant across its axial length, except for a circumferential groove 69 into which O-ring 19a is placed. This form is even easier to produce and entails less expense.

Furthermore, due to deep-drawn inflow nipple 12 and nozzle body 2, it is possible to use a multitude of existing components from conventional fuel injectors 1.

An additional advantage of deep-drawn inflow nipple 12 is the possibility of mounting it only after the dynamic flow rate has been set by adjusting the initial tension of restoring spring 38 with the aid of a sleeve 70. This provides simpler adjustability of fuel injector 1 since the adjusting tools need not be threaded through inflow nipple 12. The required tools must therefore not be modified for the different settings for inflow nipples having different lengths, which allows a shorter process time and therefore also provides cost savings.

The present invention is not limited to the exemplary embodiment shown and is also applicable, for instance, to fuel injectors 1 to be used in self-ignitable internal combustion engines.

1-18. (canceled)

19. A fuel injector for a fuel-injection system of an internal combustion engine, comprising:
an inflow nipple for connection to a fuel-distributor line;
a nozzle body disposed downstream from the inflow nipple; and
a magnetic circuit element, which includes a solenoid coil, an inner pole, and an outer pole, and an armature, which is in force-locking connection with a valve needle so that a valve-closure element disposed on the valve needle lifts off from a valve-seat surface when solenoid coil is energized;
wherein the inflow nipple and the nozzle body are produced as deep-drawn components, and the inflow nipple and the nozzle body are fixed in place on the magnetic circuit element.

20. The fuel injector of claim 19, wherein the inflow nipple is held in place at the inner pole with a welding seam.

21. The fuel injector of claim 19, wherein the nozzle body is held in place at the outer pole with a welding seam.

22. The fuel injector of claim 20, wherein the welding seam is produced by laser welding.

23. The fuel injector of claim 19, wherein a radial diameter of the nozzle body is stepped across its axial length.

24. The fuel injector of claim 23, wherein the nozzle body has a first flange and a second flange.

25. The fuel injector of claim 24, wherein an annular seal is disposed between the flanges.

26. The fuel injector of claim 19, wherein, except for a groove, a radial diameter of the nozzle body is constant across its axial length.

27. The fuel injector of claim 26, wherein an annular seal is disposed inside the groove.

28. The fuel injector of claim 19, wherein the inflow nipple has a flange.

29. The fuel injector of claim 19, wherein a spacer is disposed around the inflow nipple.

30. The fuel injector of claim 28, wherein an annular seal is disposed between the flange and the spacer.

31. The fuel injector of claim 29, wherein the spacer is one piece and disposed on the inflow nipple so as to be axially displaceable.

32. The fuel injector of claim 29, wherein the spacer is the form of two semi-spheres.

33. A method for mounting a fuel injector for a fuel-injection system of an internal combustion engine, having an inflow nipple for connection to a fuel-distributor line, a nozzle body disposed downstream from the inflow nipple, and a magnetic circuit element, which includes a solenoid coil, an inner pole, an outer pole, and an armature, which is in force-locking connection with a valve needle so that a valve-closure element disposed on the valve needle lifts off from a valve-seat surface when solenoid coil is energized, the inflow nipple and the nozzle body being produced as deep-drawn components, and the inflow nipple and the nozzle body being fixed in place on the magnetic circuit element, the method comprising:
preassembling the magnetic circuit element;
placing the nozzle body and welding it to the outer pole;
setting a dynamic flow rate of the fuel injector by adjusting an initial tension of a restoring spring;
premounting a spacer on the inflow nipple; and
placing the inflow nipple and welding it to the inner pole.

34. The method of claim 33, wherein the premounting is switchable in the sequence of operations.

35. The method of claim 33, wherein the premounting of the spacer includes slipping the spacer onto the inflow nipple prior to welding the inflow nipple to the inner pole, and an axial displacement of the spacer in a discharge direction across a welding seam that connects the inflow nipple to the inner pole.

36. The method of claim 33, wherein the premounting of the spacer includes mounting the spacer made up of two semi-spheres on the inflow nipple after welding the inflow nipple to the inner pole.
